(19) United States
(12) Patent Application Publication
(10) Pub. No.: US 2009/0292378 A1
(43) Pub. Date: Nov. 26, 2009

(54) Linking Media Displays with Performance Enhancements and Methods Thereof

(75) Inventors: Michael Craig, Georgetown, KY (US); Mark Craig, Lexington, KY (US); Timothy Craig, Georgetown, KY (US); Daniel Maggart, Georgetown, KY (US); Douglas Anderson, Frankfort, KY (US); Garon Rucker, Lexington, KY (US)

Correspondence Address: DINSMORE & SHOHL LLP, 1900 CHEMED CENTER, 255 EAST FIFTH STREET, CINCINNATI, OH, 45202, US

(73) Assignee: COREVALUS SYSTEMS, LLC, Georgetown, KY (US)

(21) Appl. No.: 12/471,963

(22) Filed: May 26, 2009

Related U.S. Application Data
(60) Provisional application No. 61/055,589, filed on May 23, 2008.

(51) Int. Cl. G06F 17/00

(52) U.S. Cl. 700/94

(57) ABSTRACT

Methods for controlling performance enhancement systems by a media display system include displaying performance information on the media display system, determining a state of the media display system, and controlling one or more performance enhancement systems based on the state of the media display system.

### CROSS-REFERENCE TO RELATED APPLICATIONS

This application claims the benefit of U.S. Provisional Application Ser. No. 61/055,589, filed May 23, 2008 entitled “Linking Music Display with Audio Control.” The aforementioned application is incorporated herein by reference in its entirety.

### TECHNICAL FIELD

The present application relates generally to music display systems and, in particular, music display systems that can communicate and control related systems based on the current state of the music display system.

### BACKGROUND OF INVENTION

Some music systems allow for a user to have preset settings for various audio devices. These devices may consist of a personal mixer that allows a musician to mix their own audio settings using a small box with knobs and buttons located at their music station. Typically, the presets are tied to pre-selected settings for designated control states that may be stored in designated saving areas such as “preset 1” or “preset 2”. The presets, however, are not tied to any music display system or any part of the actual performance which creates a lack of integration and a lack of efficiency.

### SUMMARY OF INVENTION

In one embodiment, a method for controlling performance enhancement systems by a media display system is provide. The method includes displaying performance information on the media display system, determining a state of the media display system, and controlling one or more performance enhancement systems based on the state of the media display system.

In another embodiment, a system for linking a media display with performance enhancements is provided. The system includes a media display system operable to display performance information and a control system in control of a performance enhancement system, wherein the control system is in communication with the media display such that the control system controls the performance enhancement system based on a state of the media display system.

In yet another embodiment, a media display network for dynamically adjusting performance controls is provided. The media display network includes a master display, a plurality of remote displays, a central computer in communication with the master display and the plurality of remote displays, wherein the central computer controls what is displayed on the master display and the plurality of remote displays, and, a plurality of performance enhancement systems in communication with the central computer, wherein the central computer controls the plurality of performance enhancement systems based on what is displayed on the master display and the plurality of remote displays.

These and additional features and advantages will be more fully understood in view of the following detailed description.

### DETAILED DESCRIPTION OF INVENTION

Performance enhancement systems may be controlled by linking media display systems with control systems such that the control systems may adjust the performance enhancement systems based on what is displayed on the media display. This may allow for audio or visual effects of a performance to be dynamically adjusted for the performer and/or the audience based on which music, speech, or particular portions thereof are currently displayed on a performer's display or stand. Dynamic adjustment may include the ability to repeatedly or continuously control performance enhancement systems throughout a performance.

A media display system may have the ability to communicate with a control system to control performance enhancement systems based on cues from the current state of the media display system. Performance enhancement systems may comprise any audio, visual, or other sensory related system that adjusts the way in which a performance is perceived by an audience or the performers themselves. For example, performance enhancement systems may comprise audio mixers, audio control systems, musical instrument settings, music track play back systems, midi devices, audio playback systems, video playback systems, synthesizers, digital effects systems, fog machines, laser light devices, lighting controllers, visual presentation systems, or other related devices.

In one embodiment, performance enhancement systems may comprise an audio mixer or soundboard to mix an audio output. Mixing an audio output may comprise adjusting sound settings of the audio output or adjusting the volume outputs of particular channels of instruments or microphones such that some channels are promoted over others. Sound settings may include the adjustment of the equalizer, reverb, hall effect, chorus effect, and even distortion. In another embodiment, the performance enhancement system may comprise the media display system itself such that the media display system may alter or vary its audio output, display or functionality based on its state. For example, where a media display system is a digital music stand as will become appreciated later herein, the digital music stand may comprise a sound output for the performer using said digital music stand (for example, where the performer plugs headphones into the digital music stand). The audio output may be individually adjusted for that digital music stand to enable the performer to hear the desired audio mix of the performance. The audio mix may be controlled based on the state of the media display system (such as where the state of the media display system corresponds with which song is being played) or by operator input from the performer (such as when a mixing board is provided on the music display stand) In yet another embodiment, performance enhancement systems may comprise lighting controls that adjust the brightness of light or color of light in a hall, theater or auditorium. Performance enhancement systems may further comprise any other accessory applicable to audio, visual or other related performances.

The performance enhancement systems may further comprise digital instruments such that the audio output or sound effects of the digital instrument may be controlled. Sound effects may include the adjustment of the equalizer to promote a reverb, hall effect, or chorus effect or may even include the instrument type itself. For example, where the digital instrument comprises a digital keyboard, the digital keyboard may be operable to play a range of different instruments such as a grand piano, guitar or wind instrument such that the sound effects may vary which instrument is played.

Media display systems may comprise any device operable to display performance information to one or more performers wherein performance information may comprise any audio, visual or other instructions on what should be performed for an audience. For example, a media display system may comprise a digital music stand operable to display musical scores. In another embodiment, the media display system may comprise a lectern or pulpit operable to display a speech to be read by the performer. In yet another embodiment, the media display system may display the script or stage cues to a theater troupe during the performance of a play. Furthermore, media display systems may comprise a single media display or a plurality of media displays wherein the plurality of media displays are in sync with each other to display the proper performance information. It should be appreciated that these are only exemplary, non-liming, embodiments and that the media display system may comprise any other structure or form operable to display performance information or other related information.

In one embodiment, the media display system may be configurable to display music for a team of musicians or singers, such as in a church music team environment. For example, in one exemplary embodiment, such as a church music team environment, a church may have hundreds of songs to select from for a particular service. In the service, a subset of songs may be selected to be played. In addition, it may be desirable to occasionally change one or more of the songs, or to change the order of the songs to be played. For each song, the audio or lighting settings may be stored, quickly returned, and implemented in a performance as will become further appreciated later herein. The change in the music can be quickly sent to the one or more remote displays. Thus, the audio mixing and related device settings may be preset for a subset of songs and order of songs that may be displayed on the media display system. In another embodiment, the media display system may comprise a digital lectern comprising presentation notes at the lectern, presentation slides at the sound booth in the presentation system, and a link between the digital pulpit and the sound booth. The system would allow cues in the presentation notes to trigger events in the presentation software at the sound booth as will become appreciated later herein.

In one exemplary embodiment, the media display system may comprise a graphical user interface (GUI). The graphical user interface may be configured such that the user can visually manage the digital sheet music files stored in the local storage medium. In addition, the graphical user interface may allow the user to browse and adjust all the digital sheet music files stored in remote music databases, audio and lighting system mix capability, and other related device settings. An exemplary graphical user interface may allow a user to search the storage medium/database for digital sheet music data files and other device settings. For example, using a touch screen, the user may utilize the on-screen keyboard. The media display system may also comprise one or more input terminals or input devices. Exemplary input devices may include a touch screen, foot pedal, hand wireless remote, keyboard, a mouse and other input devices. The touch screen may be utilized in combination with the graphical user interface to allow a music team leader to adjust the song selection, song order, display format, audio and light mix settings, and other related device settings. A foot pedal may also be programmed for any programmable function. In one exemplary embodiment, the foot pedal may be used to advance the display from one digital sheet music file to the next.

The media display systems may be in communication with a control system operable to control performance enhancement systems. The media display system may comprise the control system itself, or the control system may comprise a separate unit in communication with performance enhancement systems. Furthermore, a single media display system may communicate with a single control system, a single media display system may communicate with a plurality of control systems, a plurality of media display systems may communicate with a single control system, or a plurality of media display systems may communicate with a plurality of control systems.

Control systems may be operable to analyze what is displayed on the media display system, analyze what is being performed, determine a state of the media display system and/or adjust, mix or otherwise manipulate performance enhancement systems. Control systems may thereby comprise any form of system that can control audio/video mixing of a performance such as a computer or software. The state of the media display system may comprise which page of music, song, verse, part of speech or sermon, or segment of a presentation is being displayed or may be based on operator input such as how to mix the audio or channels to be played. The state of the media display system may further comprise analyzing performance information such as which instruments are being played, who is singing (for example by implementing voice recognition software), or what song is being performed. For example, it may be common for a first singer to lead a first song and a second signer to lead a second song. It may therefore be desirable to increase the audio volume in the auditorium and monitors of the active lead singer. The sound mix and other related devices may thereby be set for the particular signer for each song. The control system may then adjust, mix or otherwise manipulate one or more performance enhancement systems based on the state of the media display system. For example, the control system may comprise an audio mixing board operable to adjust various audible traits of a sound system. The control system may adjust the output of the sound system based on the state of the media display as appreciated herein.

In one embodiment, the state of the media display system may also be influenced by operator input such as input from an operator in a control booth or from the performers themselves. For example, where input terminals are implemented throughout the system, a performer may select a specific part of the song to be played which then influences the state of the media display. Such an embodiment may give performers communication with, and control of, related systems. In one embodiment, each media display system may comprise its own mixing board such as, for example, through a touch screen display. Such an embodiment may allow for each performer to individually adjust the audio output of the media display system through controlling the channel mix that the performer hears. This may allow for a performer to hear their own channel, or that of another, in greater volume than remaining channels. Or, in another example, a band or worship leader may change songs during a performance and the system would automatically change sound mix settings, light mix settings, and other related device settings for a hall or auditorium. In another embodiment, the media display system may link the performance music or script with performance enhancement systems and related devices. In yet another embodiment, the media display system may link the song or work with presets for the audio system. Another embodiment of the present invention comprises audio and lighting mixing integrated into a music display system; audio and lighting system presets configured to adapt songs, pieces in a performance, presentations, or other states; and midi, pedal, and keyboard settings tied directly to the specific song in a performance or piece in a presentation or other state of the music display system.

In another exemplary embodiment a media display network may comprise media display systems in communication with a control system operable to control performance enhancement systems. In one embodiment, a primary unit or central computer (control station) networks and links a master display or primary unit with a plurality of remote displays or a group of secondary units. For example, the master display may comprise a touch screen display. The touch screen display may comprise a computer itself, or may be in communication with a computer. The one or more input devices, such as a foot pedal or a hand wireless remote may be operable to input data into the system such as song selection or manual audio/visual manipulation of performance enhancement systems. Each of the remote displays may be connected to the main computer via a wireless or wired connection such that the remote displays and/or master displays display performance information in sync. In a particular embodiment, each of the remote displays may be connected to a network, wherein the computer is connected to the same network. Each media display system may further comprise touch screens that may represent a sound mixing board with a software graphical user interface (GUI). Such an embodiment may comprise a mixing control at each of the musician/performer stations that may allow each person to mix their own sound using the touch display. This may allow for any station preset to mix the sound for the auditorium.

In such an embodiment, the master display or primary unit may have the functionality which includes at least one of the following: the ability to download a list of songs including the song content to one or more secondary units; the ability to select the type/part of music (e/g. trumpet part, piano part, etc.) and send the music content for the selected type for the list of songs to one or more remote displays or secondary units; the ability to synchronize the list of songs to be displayed on the remote displays or secondary units; the ability to select the play order of the songs of the play list in the remote displays or secondary units; the ability to mix the audio for the entire group, individual performance, or speaker output; the ability to mix the lighting and related device settings for the entire group, individual performance or speaker output; the ability to send commands to select the ‘now playing’ song for the remote displays or secondary units; the ability to send user-defined messages to individual remote displays or secondary units, groups of remote displays or secondary units or all of the remote displays or secondary units; the ability to edit one or more pages of a particular song and send edited pages to one or more designated remote displays or secondary units, such edits may include annotations and revised pages; the ability to receive annotations and other edits from a remote display or secondary unit and there store edited/annotated page in database; the ability to synchronize and display a timing device (e.g. metronome) or sound an audio output on selected remote displays or secondary units, as well as the ability to maintain such synchronization.

Likewise, the remote displays or secondary units may have one or more of the following functionality; the ability to operate in a networked environment or in a “stand-alone” mode; the ability to allow a user to annotate/edit/mark-up pages of music using a user input interface such as a keyboard and mouse device; the ability to allow the user to change the song or displayed page using an input device; the ability to change the song or displayed page on other remote displays or secondary units displaying the same content as primary unit; the ability to change audio and light mixing capability; the ability to change other related device settings; and the ability to send user-defined messages to the control station and/or other remote displays or secondary units.

In another exemplary embodiment, the central computer may serve as a local music management system operable to store the digital sheet music data files and device settings which may include, but are not limited to, audio and lighting mixing capabilities, and other related device settings, on an external storage medium, such as on the internet. In this embodiment, the digital sheet music data files may be accessed via an internet connection. In one exemplary embodiment, the external storage medium comprises a third-party hosted web environment, server farm, or digital storage facility. In yet another embodiment, the local music display system comprises a web-based hosted application. In this embodiment, the local music management application is hosted on a remote web server and generates various web pages to manage the local music display system.

Yet another embodiment would incorporate software that allows a user to utilize an input device or input terminal as discussed above. The input terminal may, for example, be a foot pedal operable to select the song and verse of the song to be played whereby the sound settings, and other related device settings, could be cued to the set points of the song with input foot pedal cues. For example, bands having a single guitar player only, and with this software, the person could press a button to play the bass, piano, saxophone, and other musical instruments to accompany parts of the song. Another embodiment could allow use of a touch screen, a hand remote, or any other type of input terminal such as a keyboard. Input terminals could also send cues to the software to play a particular verse or chorus or simply provide another way that the media display system controls performance enhancement systems.

In one embodiment, the media display system may combine audio mixing with a music display system program such as SamePage™ from Corevalus Systems. The music display system may act as the control system and communicate with the audio mixing system and control the audio mix for either the auditorium, the performer monitors/displays, and/or other audio devices. It may further allow for presets to be tied to a song, piece of presentation, or other state. A multi-display support, also referred to as a multi-screen and multi-monitor, may allow a user of a computer system, or a central computer, to utilize more than one display at a time from a single system wherein the plurality of displays are in synchronization. The music display system may communicate through standard networking protocols to a digital audio system.

It should now be appreciated that a system which allows a user to tie presets to the actual piece of music performed. Presets could be linked to parts of a play, bullet points of a presentation, or other related performance aspects. The presets are not limited to audio and lighting presets. Presets may also include presentation settings, video settings, digital effects settings, laser light settings, and other related device settings. Beyond music, media display systems linked to external contracts may also be used for presentations, plays, sermons, and other related applications. Control of audio, lighting, and other device settings may be tied to states of the media display system or cues in presentations, sermons, or plays. States or cues may stem from certain voices, sound settings, or software inputs.

The foregoing description of the various embodiments and principles of the invention has been presented for the purposes of illustration and description. It is not intended to be exhaustive or to limit the invention the precise forms disclosed. Many alternatives, modifications, and variations will be apparent to those skilled in the art. For example, some of the principles of this invention may be utilized in different multi-display systems such as educational purposes, advertising, music groups, and the like. Moreover, although model concepts have been presented, such aspects need not be utilized in combination, and various combinations of inventive aspects are possible in light of the various embodiments provided above. Accordingly, the above description is intended to embrace all possible alternatives, modifications, combinations, and variations, and have been discussed or suggested herein, as well as all others that fall within the principles, spirit, and broad scope of the invention as defined by the claims.

What is claimed is:

1. A method for controlling performance enhancement systems by a media display system, the method comprising:
displaying performance information on the media display system;
determining a state of the media display system; and
controlling one or more performance enhancement systems based on the state of the media display system.

2. The method of claim 1 wherein the state of the media display system corresponds with the displayed performance information and/or operator input.

3. The method of claim 2 wherein the media display system comprises a digital music stand and the displayed performance information comprises a composition selected from a play list.

4. The method of claim 3 wherein the one or more performance enhancement systems comprises an audio output from the digital music stand such that controlling the one or more performance enhancement systems comprises mixing the audio output from the digital music stand.

5. The method of claim 3 wherein the one or more performance enhancement systems comprises audio and/or lighting systems such that controlling the one or more performance enhancement systems comprises mixing the audio and/or lighting systems.

6. The method of claim 1 wherein the one or more performance enhancement systems are controlled using midi protocol.

7. The method of claim 1 wherein the one or more performance enhancement systems comprises a digital instrument.

8. The method of claim 7 wherein controlling the one or more performance enhancement systems comprises controlling the sound effect of the digital instrument.

9. A system for linking media displays with performance enhancements, the system comprising:
a media display system operable to display performance information; and
a control system in control of a performance enhancement system, wherein the control system is in communication with the media display such that the control system controls the performance enhancement system based on a state of the media display system.

10. The system of claim 9 wherein the state of the media display system is determined by the displayed performance information.

11. The system of claim 9 wherein the media display system comprises a digital music stand.

12. The system of claim 11 wherein the performance enhancement system comprises an audio output from the digital music stand.

13. The system of claim 12 wherein the state of the media display system is a composition displayed on the digital music stand.

14. The system of claim 13 wherein the control system is integrated within the digital music stand.

15. The system of claim 14 comprising a plurality of digital music stands each comprising a control system integrated therein and an individual audio output mix controlled by the control system integrated therein.

16. The system of claim 9 wherein the control system controls a plurality of performance enhancement systems.

17. The system of claim 9 wherein operator input controls the state of the media display system.

18. A media display network for dynamically adjusting performance controls, the media display network comprising:
a master display;
a plurality of remote displays;
a central computer in communication with the master display and the plurality of remote displays, wherein the central computer controls what is displayed on the master display and the plurality of remote displays; and,
a plurality of performance enhancement systems in communication with the central computer, wherein the central computer controls the plurality of performance enhancement systems based on what is displayed on the master display and the plurality of remote displays.

19. The media display network of claim 18 wherein the master display comprises the central computer.

20. The media display network of claim 18 wherein the plurality of remote displays comprise a plurality of digital music stands.
